(19) United States
(12) Patent Application Publication
(10) Pub. No.: US 2009/0266190 A1
(43) Pub. Date: Oct. 29, 2009

(54) MULTI-GROUP TRANSMISSION OF A MOTOR VEHICLE

(75) Inventors: Alan DITTRICH, Konstanz (DE); Rayk HOFFMANN, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/427,790

(22) Filed: Apr. 22, 2009

(30) Foreign Application Priority Data
Apr. 28, 2008 (DE) 10 2008 001 407.9

(51) Int. Cl. F16H 3/08

(52) U.S. Cl. 74/331

(57) ABSTRACT

A multi-group transmission of a motor vehicle and a method of operating the transmission. The transmission has at least two transmission groups in the drive train and a mechanism for engaging an intermediate gear to reduce drive force interruptions during gearshifts. To obtain comfortable, shift operations that are free from drive force interruptions by way of an intermediate gear, a starting element and a shift-under-load element are arranged between a drive shaft, that is actively connected to a motor, and a transmission input, such that by way of the shift-under-load element, an active connection is formed between the driveshaft and a transmission output shaft, via at least one auxiliary shaft made as an intermediate gear shaft, with a drive input gearset and at least one drive output gearset bypassing at least a main group and independent of the engagement or disengagement of the starting element.

This application claims priority from German patent application serial no. 10 2008 001 407.9 filed Apr. 28, 2008.

### FIELD OF THE INVENTION

The invention concerns a multi-group transmission of a motor vehicle and a method of operating a multi-group transmission of a motor vehicle.

### BACKGROUND OF THE INVENTION

Multi-group transmissions consist of two or more transmission groups usually arranged in series, by the combination of which a large number of gears can be produced. Increasingly, they are designed as automated manual transmissions, for example consisting of an input group, a main group and a range group. Such transmissions are used in particular in utility vehicles, since they enable a particularly fine gradation of gears, for example with 12 or 16 gears, and because their efficiency is high. With a smaller number of gears, configurations are also possible which consist only of a main group and an input group, or a main group and a range group. Furthermore, compared with standard manual transmissions they are characterized by great operating comfort and, compared with automatic transmissions, their production and operating costs are particularly economical.

By virtue of their structure conventional multi-group manual transmissions, in common with all standard or automated manual transmissions in which shifts take place not under load, undergo a traction force interruption during gear changes, since the flow of drive from the drive engine is always interrupted by disengaging a clutch in order to disengage the engaged gear while it is free from load, to synchronize the transmission and the drive engine to a connection speed while in a neutral position, and then to engage the target gear. This restricts the driving performance because of some speed loss and sometimes leads to higher fuel consumption. Whereas in passenger cars the traction force interruptions, since they only affect the driving dynamics, are as a rule perceived as merely annoying, for example during a driving mode inclined toward sportiness, in the case of heavy utility vehicles driving uphill the driving speed may fall to such an extent that an upshift becomes impossible and the driver is compelled to carry out undesired downshifts, to creep-drive, or even to carry out additional starting operations.

Solutions have already been proposed, which reduce or entirely avoid these traction force interruptions. From DE 10 2006 024 370 A2 by the present applicant an automated multi-group transmission of such type is known, which comprises a splitter group as the input gear system, a main transmission, and a range group as the output or downstream transmission. The structure of the known multi-group transmission with its input gear system and its main transmission enables the engagement of a direct gear as an intermediate gear during a gear change. For this purpose a direct connection is temporarily formed by means of a shift-under-load clutch between an input shaft of the input system and a main shaft of the main transmission. This frees the main transmission and the splitter group from any load, so that the gear engaged can be disengaged, the transmission synchronized and the target gear engaged, while the starting clutch remains coupled. In this case the shift-under-load clutch transmits an engine torque to the transmission output, and a dynamic torque that becomes free if there is a drop in speed between the original gear and the target gear is used in order largely to compensate the traction force loss. The shift-under-load clutch can be arranged between the input transmission and the main transmission or between the starting clutch and the input transmission. The transmission ratio of the intermediate gear is determined by the direct connection of the input shaft to the main shaft as a direct gear. Variable intermediate gears are not provided. In addition, shifting of the range group is not necessarily assisted by the traction force.

Furthermore, from DE 10 2004 002 283 A1 by the present applicant, a drive mechanism with a manual transmission is known, in which a shift brake clutch is arranged between a drive motor and a starting clutch. The shift brake clutch can be actively connected to a transmission output via an auxiliary shaft and a gearset. During a gearshift the starting clutch is opened while the shift brake clutch is engaged at the same time, whereby a torque transmitted by the shift brake clutch is applied to the transmission output and the drive torque of the drive motor is reduced. By virtue of this torque reinforcement of the transmission output the complete traction force interruption that is usual in change-speed transmissions is prevented. In an upshift process the motor speed is reduced by the speed difference produced by the gearshift with torque reinforcement, whereby the shift pause until completion of the gearshift process can be shortened. The length of the traction force reduction is thus reduced. The manual transmission can be both a conventional manual or automated gear transmission, and a basic transmission with a downstream range group.

Regarded as disadvantageous in the above is the fact that the starting clutch is disengaged during the gearshift. On the one hand the traction force interruption is only reduced and made shorter, and on the other hand, since the starting clutch is disengged during the gearshift, the shift brake clutch must be connected upstream from the starter clutch in the force flow. Depending on the structure of the transmission, this may entail a relatively high implementation cost. Moreover, the intermediate gear is re-routed via just one auxiliary shaft, and because of this, in transmissions with two countershafts the branching of the force flow is not as optimal. References to the possibility of being able to engage various intermediate gear ratios are not to be found in DE 10 2004 002 283 A1. In contrast, it would be desirable to have an intermediate gear arrangement flexibly adaptable for various group transmission structures, particularly in relation to specified mounting situations and the shifting comfort desired.

### SUMMARY OF THE INVENTION

Against this background the purpose of the present invention is to provide a multi-group transmission and a method for its operation, which enable shift processes to be carried out without interruption of the traction force by virtue of a flexibly adaptable intermediate gear, having particular regard to the mounting situation, the shifting comfort and the transmission ratio, and involving the lowest possible construction effort and costs.

The invention is based on the realization that in an automated multi-group transmission, by means of one or more auxiliary shafts via which a drive torque can be applied to the transmission output, and a change-under-load element made as a single or double clutch that acts upon the auxiliary shafts with a drive torque during a shift operation, an intermediate gear that enables comfortable gearshifts of the transmission as a whole without traction force interruption to be carried out without elaborate modifications of the existing transmission groups.

Accordingly, the invention starts from a multi-group transmission of a motor vehicle, with at least two transmission groups arranged in a drivetrain, in which means are provided for engaging an intermediate gear in order to reduce or avoid traction force interruptions during gearshifts. To achieve the stated objective, the invention also provides that a starting element and a shift-under-load element are arranged between a driveshaft, actively connected to a drive motor, and a transmission input, so that by means of the shift-under-load element an active connection that by passes at least one main group can be formed between the driveshaft and a transmission output shaft, independently of the extent to which the starting element is engaged or disengaged, by means of at least one auxiliary shaft made as an intermediate gear shaft with a drive input gearset and at least one drive output gearset.

A gearshift is understood to mean a shift operation in which an original gear is disengaged and a target gear is engaged, including the special case that the target gear is the same as the original gear so that no transmission ratio change takes place.

In addition, the invention starts from a method for operating a multi-group transmission of a motor vehicle, with at least two transmission groups arranged in a drivetrain, in which an intermediate gear is engaged during a gearshift in order to reduce or avoid traction force interruptions. The stated objective in relation to the method is achieved in that to engage an intermediate gear during a gearshift, by means of a shfit-under-load element actuated in the engagement direction an active connection that bypasses at least one main group is formed, via at least one auxiliary shaft designed as an intermediate gear shaft, between a driveshaft and a transmission output shaft, so that at least the main group, with a starting element arranged between the driveshaft and a transmission input shaft in an at least partially engaged condition, can be shifted while free from load, then an engaged original gear is disengaged, the speed of a drive motor that drives the driveshaft is synchronized, with the shift-under-load element in slipping operation, to a connection speed of a target gear, and when the connection speed has been reached, the target gear is engaged and the shift-under-load element is again disengaged.

By engaging the intermediate gear, the main group and, if present, the splitter group are freed from load and can therefore be shifted. In slipping operation the additional clutch applies the motor torque, via the intermediate gear shaft, to the drive output during a traction upshift or a traction downshift, while the motor speed is being adapted to the target speed of the target gear. When the synchronous speed has been reached the desired target gear can be engaged. In this way it is basically also possible to carry out traction-force-supported gearshifts with shift intervals covering two or more gear steps.

During the shift operation the starting element always remains engaged. However, it would also be possible for the starting element to be operated in slipping mode or to be disengaged during the intermediate gear shift. Rather, however, the greatest reduction of the traction force interruption, even to the point of completely maintaining the traction force, can be achieved by keeping the starting element fully engaged. Moreover, oscillations and jerky shifts are largely avoided since during the gearshift the drivetrain remains under continual load by virtue of the intermediate gear. Furthermore, as a rule a transmission brake can be omitted and thus costs, structural space and weight saved, since the rotating masses in the drivetrain that have to be synchronized during the gearshift can be braked by the intermediate gear.

The intermediate gear engagement according to the invention can be used particularly advantageously in automated multi-group transmissions with three transmission groups. In the case of such a transmission, for example fitted in a moderately heavy or heavy utility vehicle, an upstream two-gear splitter group associated with a transmission input shaft and multi-gear main group associated with a main transmission shaft can be made as countershaft transmissions and a downstream range group as a planetary transmission.

Furthermore, the starting element and the shift-under-load element can be made as a structurally space-saving double clutch, such that an input component of the double clutch is connected to the driveshaft, an output component of the starting element is connected to the transmission input shaft, and an output component of the shift-under-load element is connected to a loose wheel of the drive input gearset mounted to rotate on the transmission input shaft.

It is also possible for the shift-under-load element and the starting element to be arranged as separate elements one behind the other. In this case an input component of the shift-under-load element and an input component of the starting element are connected to one another and to the driveshaft. An output component of the starting element is connected to the transmission input shaft and an output component of the shift-under-load element is connected to the loose wheel of the drive input gearset mounted to rotate on the transmission input shaft. Since during the shift operation the starting element always remains engaged or at least partially engaged, the positioning of the starting element and the shift-under-load element can basically be varied, so that the additional clutch for shifting the intermediate gear can be fitted into an existing transmission design with the least possible complication.

The intermediate gear can be shifted by means of the double clutch or the second clutch. For this purpose the clutch, at the transmission input, acts via the loose wheel upon the drive input gearset with the motor torque applied. The loose wheel of the drive input gearset can be engaged directly with a fixed wheel arranged on the at least one auxiliary shaft, or it may mesh with an additional, intermediate wheel for its part engaged with the fixed wheel.

A drive output gearset serves to reinforce the torque at the transmission output. The drive output gearset can be arranged axially at the level of the transmission output shaft. It comprises a fixed wheel arranged on the auxiliary shaft, which is directly engaged with a fixed wheel arranged on the transmission output shaft, or meshes with an additional, intermediate wheel that, for its part, is in meshing engagement with the fixed wheel on the transmission output shaft. Thus, the intermediate gear bypasses the entire transmission, transferring the motor torque directly to the transmission output.

In principle the output gearset can also be connected downstream from the main group, in which case it will comprise a fixed wheel arranged on the auxiliary shaft which engages directly with a fixed wheel on the main transmission shaft or meshes with an additional, intermediate wheel that, for its part, meshes with the fixed wheel on the main transmission shaft. In such a case the intermediate gear would only bypass the upstream group and the main group and transmit the torque to the downstream group.

In addition to a simple intermediate gear with a fixed intermediate gear ratio, optionally selectable intermediate gear ratios can be made available by one or more further output gearsets. In particular, a second output gearset can be arranged downstream from the main group, which comprises a loose wheel on the at least one auxiliary shaft which is directly engaged with a fixed wheel on the main transmission shaft or which meshes with an additional intermediate wheel that, for its part, engages with a fixed wheel arranged on the main transmission shaft, with a shift device that interrupts the auxiliary shaft arranged between the two output gearsets, which optionally connects the loose wheel of the second output gearset rotationally fixed to the auxiliary shaft or terminates the interruption of the auxiliary shaft by frictional means.

The second output gearset can for example be arranged between the main group and the range group. In this way suitable control means can selectively actuate either one or the other output gearset, so as to select its gear ratio. When the second output gearset is actuated the range transmission must additionally be taken into account. Depending on the shift position a direct transmission i=1 of the range group to the drive output is obtained, i.e. the gear ratio of the output gearset is passed on unchanged, or if necessary, a gear ratio i≠1 of the range group must additionally be taken into account.

It can also be provided that at least one countershaft is made as a hollow shaft through which the at least one auxiliary shaft made as an intermediate gear shaft passes coaxially. Such a coaxial arrangement of the countershaft and intermediate gear shaft does not increase the diameter of the transmission and therefore gives a particularly compact structural form of the multi-group transmission with its intermediate gear. This is especially advantageous since the mounting space in modern vehicles is in any case usually restricted.

In transmissions with only one countershaft, also only one auxiliary shaft suffices for the diversion of the torque flow by the intermediate gear. In contrast, in a transmission with two countershafts it is preferable for the torque flow to branch via two auxiliary shafts arranged axis-parallel with one another, one auxiliary shaft being on the side of each countershaft. The driving and output gearsets of the auxiliary shafts then have to be correspondingly extended.

As an advantageous combination that gives particularly great shifting comfort while being structurally compact, it is possible to have, for example, a two-countershaft structure with hollow countershafts and intermediate gear shafts passing through them, with an upstream double clutch as the starting and intermediate gear clutch and with an additional, second output gearset between the main group and the range group for the optional or situation-adapted engagement of various intermediate gear ratios. Needless to say, combinations other than that described or embodiments which those with knowledge of the subject can easily derive from them, are also possible.

### BRIEF DESCRIPTION OF THE DRAWINGS

To clarify the invention the description of a drawing with two example embodiments is attached. The drawing shows:

FIG. 1: Layout of a multi-group transmission of a motor vehicle, with auxiliary shafts for engaging an intermediate gear, and

FIG. 2: A second embodiment of a multi-group transmission of a motor vehicle, with auxiliary shafts for engaging an intermediate gear

### DETAILED DESCRIPTION OF THE PREFERRED EMBODIMENTS

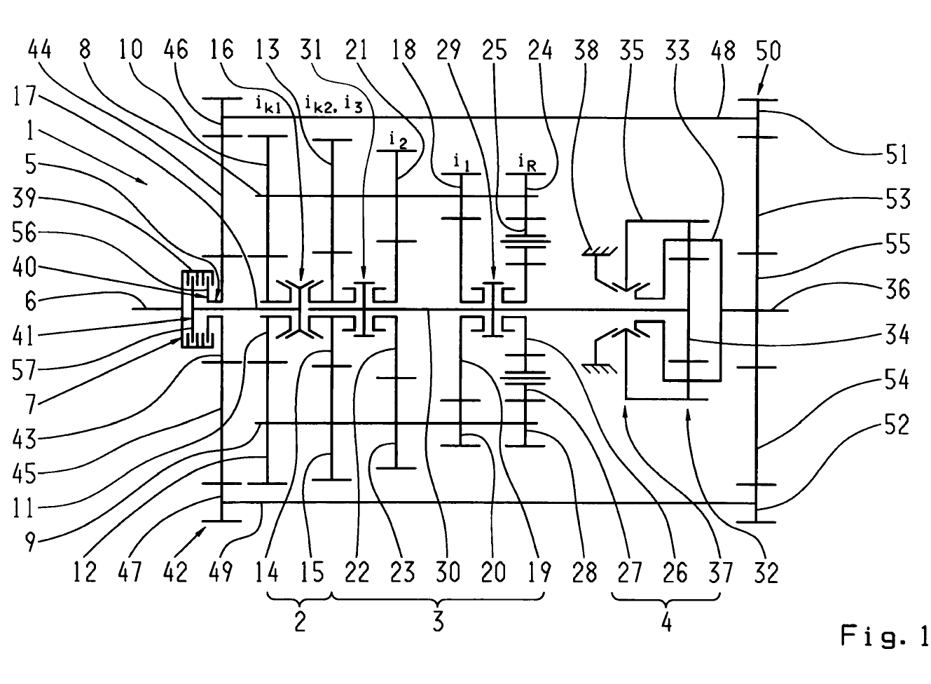

Accordingly, FIG. 1 shows an automated multi-group transmission designed as a two-countershaft transmission 1 with two countershafts 8, 9 mounted to rotate parallel to one another and with three transmission groups 2, 3 and 4 arranged one after another, as can be provided for example in the drivetrain of a truck. Such a transmission is known per se, i.e. without any intermediate gear engagement system, in particular from the ZF-AS Tronic series and with an intermediate gear engagement system from DE 10 2006 024 370 A1 by the present applicant, mentioned earlier.

The first transmission group 2, arranged on the motor side, is made as a two-gear splitter transmission. The second, central transmission group 3 is formed by a three-gear main or basic transmission. A transmission group 4 arranged on the drive output side is a downstream two-gear range transmission.

The splitter transmission 2 has two gear constants iₖ₁, iₖ₂, each comprising a fixed wheel arranged rotationally fixed on the first countershaft 8 and on the second countershaft 9, namely 10, 12 and 13, 15 respectively, which mesh with a loose wheel 11 or 14 respectively. To engage the gear constants iₖ₁, iₖ₂ a shift device 16 is provided, advantageously with synchronization, by means of which the loose wheels 11 or 14 can optionally be connected rotationally fixed to a transmission input shaft 17.

The main transmission 3 has three forward gears i₁, i₂ and i₃and one reverse gear i_{R}. The 1st and 2nd gears each have two fixed wheels 18, 20 and 21, 23 respectively, and one loose wheel 19 or 22 respectively. The 3rd gear is produced in combination with the second gear constant iₖ₂ of the splitter group 2. The reverse gear i_{R} comprises two fixed wheels 24, 28, a loose wheel 26 and two freely rotating intermediate wheels 25, 27 for reversing the rotation direction, which mesh on one side with the respective associated fixed wheel 24 or 28 and on the other side with the loose wheel 26. To engage the 1st gear and the reverse gear a shift device 29 with shift claws is provided, by means of which the associated loose wheels 19 or 26 can selectively be connected rotationally fixed to a main transmission shaft 30. To engage the 2nd and 3rd gears a claw-type shift device 31 is provided, by means of which the respective associated loose wheel 14 or 22 can selectively be coupled rotationally fixed to the main transmission shaft 30.

The downstream range transmission 4 is formed as a planetary transmission. In it, a planetary gearset 32 is guided by a planetary gear carrier 33. The planetary gears mesh on one side with a central sun gear 34 and on the other side with an outer ring gear 35. The sun gear 34 is connected to the main transmission shaft 30. The planetary gear carrier 33 is in turn connected to a transmission output shaft 36. To shift the range transmission 4 a shift device 37, advantageously with synchronization, is provided. In a first shift position this shift device 37 connects the ring gear 35 to a housing 38, or in a second shift position it locks the ring gear 35 to the planetary gear carrier 33.

From the combination of the transmission groups 2, 3 and 4 in the transmission layout shown, a total of 2×3×2=12 gears can be obtained. The force flow of the transmission 1 branches in accordance with a shift sequence in which, beginning with the 1st gear in the main transmission 3, the splitter group 2 and the main group 3 are first shifted through in alternation so that, in succession, 2×3=6 gears of a lower gear range “1st gear to 6th gear” are engaged. When the 6th gear is reached, the range group 4 switches over and the main group 3 and the splitter group 2 are again shifted through in alternation so that again 2×3=6 gears are engaged, but this time in an upper gear range “7th gear to 12th gear”. The upstream splitter group 2 also engages the reverse gear ratio i_{R} in alternation, so that two reverse gears are also available.

Between a driveshaft 6 of a drive motor (not shown) and the transmission input 5 there is arranged according to the invention a double clutch 7 advantageously formed as a disk clutch. The double clutch 7 comprises an outer cylindrical input portion 39 with driving friction disks, which is connected in a rotationally fixed manner to the driveshaft 6. The input portion 39 encloses two inner output portions 56 and 57 with driven friction disks (not shown). The output portion 57 nearest to the driveshaft 6, together with the input portion 39, forms a starting element 41. The output portion 57 of the starting element 41 is connected in a rotationally fixed manner to the transmission input shaft 17. The output portion 56 nearest to the transmission input 5, together with the input portion 39, forms a shift-under-load element 40 for engaging an intermediate gear. The output portion 56 of the shift-under-load element 40 is in fixed connection with a loose wheel 43 of a drive input gearset 42 mounted to rotate on the transmission input shaft 17.

The drive input gearset 42 is positioned between the double clutch 7 and the splitter group 2, i.e. it is upstream from the gear steps. The loose wheel 43 is engaged with two intermediate wheels 44 and 45 arranged opposite one another, each of these meshing with a respective fixed wheel 46, 47 attached on an auxiliary shaft 48, 49. The two axis-parallel auxiliary shafts 48, 49 bypass the transmission groups 2, 3 and 4 to the drive output 36. The output of the auxiliary shafts 48, 49 is formed by a drive output gearset 50 downstream from the range group 4. In each case a fixed wheel 51, 52 of the output gearset 50, arranged on the corresponding auxiliary shaft 48, 49, engages with an intermediate wheel 53 or 54. The intermediate wheels 53 and 54 opposite one another mesh with another, fixed wheel 55 arranged on the transmission output shaft 36. Thus, by means of the shift-under-load element 40, an active connection can be formed between the driveshaft 6 and drive motor, and the transmission output shaft 36 or a drive axle (not shown) acted upon by the transmission output shaft 36, this connection bypassing the three transmission groups 2, 3 and 4, so that the flow of torque branches via the two auxiliary shafts 48, 49.

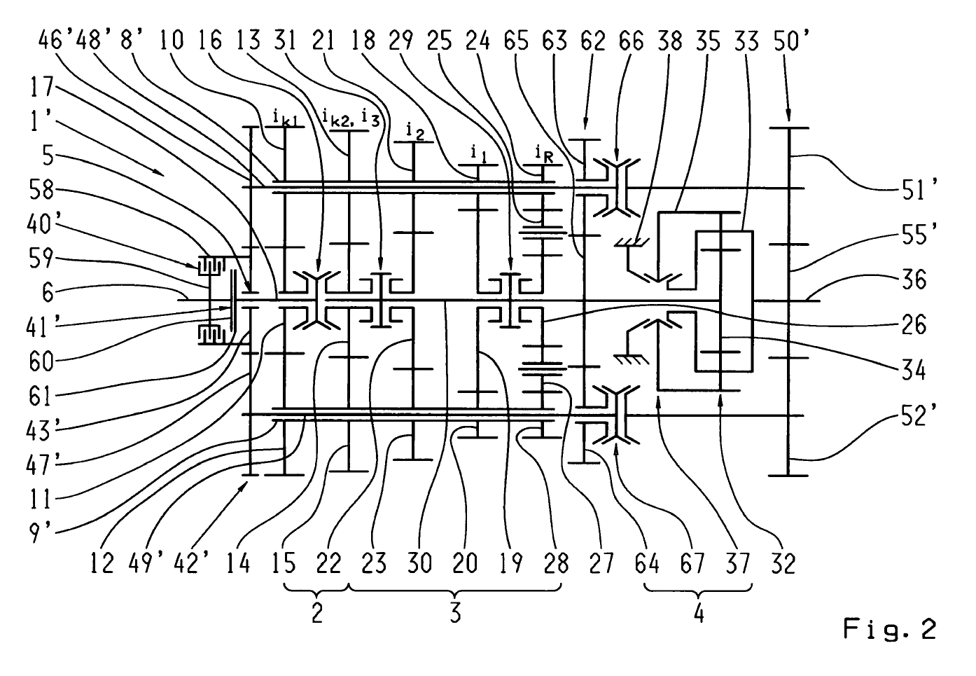

FIG. 2 shows a comparable two-countershaft transmission 1. Two countershafts 8′, 9′ are made as hollow shafts through which a respective auxiliary shaft 48′, 49′ passes coaxially. A drive input gearset 42′ comprises a loose wheel 43′ mounted on the transmission input shaft 17, which meshes with two respective fixed wheels 46′, 47′ of the auxiliary shafts 48′, 49′ opposite one another. The drive input gearset 42′ can be acted upon by a change-under-load element 40′, made as a friction clutch, for engaging an intermediate gear, i.e. for forming an active connection between the drive input and the drive output during the actuation of one or more of the shift devices 16, 29, 31, 37 for a shift operation of the transmission groups 2, 3 and 4.

The shift-under-load element 40′ is arranged between the drive motor (not shown) and a separate, conventional starting element 41′. An inner input portion 59 of the shift-under-load element 40; is attached on the driveshaft 6. An input portion 60 of the starting element 41′ is positioned downstream from the input portion 59. An output portion 61 of the starting element 41′ is connected to the transmission input shaft 17. An output portion 58 of the shift-under-load element 40′, in contrast, is connected to the loose wheel 43′ of the drive output gearset 42 of the auxiliary shafts 48′, 49′.

In addition, two drive output gearsets 50′, 62 of the auxiliary shafts 48′, 49′ are provided. As in the example embodiment of FIG. 1, one output gearset 50′ is arranged directly on the transmission output. It comprises a fixed wheel 51′, 52′ for each auxiliary shaft 48′, 49′, these being engaged with a fixed wheel 55′ arranged on the transmission output shaft 36.

Optionally, instead of this drive output 50′ the second output gearset 62 can be engaged. This output gearset 62 is positioned between the main transmission 3 and the range group 4. It comprises on each auxiliary shaft 48′, 49′ a respective loose wheel 63 or 64 which engage with a fixed wheel 65 arranged on the main transmission shaft 30. The loose wheels 63, 64 can each be connected rotationally fixed to the respective auxiliary shaft 48′, 49′ by an associated shift device 66 or 67. The shift devices 66, 67 interrupt the auxiliary shafts 48′, 49′, so that when an intermediate gear is engaged, optionally either the output-side drive output gearset 50′ or alternatively the additional drive output gearset 62 can be activated to reinforce the drive torque directly on the transmission output shaft 36 or on the main transmission shaft 30.

A method according to the invention for operating the transmission 1, 1′ is carried out as follows. When a gearshift is called for during operation the starting element 41, 41′ remains fully engaged. The intermediate gear is engaged. This is done by operating the shift-under-load element 40, 40′ in a slipping condition. The motor torque of the drive motor is thus transmitted, via the drive input gearset 42, 42′, the auxiliary shafts 48, 49 or 48′, 49′ and the output gearset 50, 50′ to the transmission output shaft 36 or, optionally, via the output gearset 62 to the main transmission shaft 30 and from there via the range group 4 to the transmission output shaft 36. Thus, by selecting the output gearset 50, 50′, 62 and if appropriate the shift position of the range group 4, various intermediate gear ratios can be produced. In each case the motor torque bypasses the main transmission 3 and the upstream splitter group 2 and is transmitted to the drive output, i.e. via the driven vehicle wheels to the road. Consequently the main transmission 3 and the splitter group 2 are free from load even with the starting element 41, 41′ engaged, and can be shifted. By means of a transmission control unit (not shown) the originally engaged gear is disengaged, but thanks to the torque transmission of the intermediate gear the traction force is maintained.

In an upshift process, during the torque transmission the motor speed is reduced by the slipping shift-under-load element 40, 40′ to a synchronous speed of a target gear. The torque that becomes free due to the speed reduction is used to compensate the traction force interruption while the shift elements involved are in the neutral position. As soon as the synchronous speed is reached, the target gear in the main transmission 3 is engaged and if appropriate the splitter group 2 is shifted via a transient neutral position to the new gear constant or the previous one corresponding to the shift sequence or the selected gear interval. Finally, if necessary overlapping with the engagement of the target gear, the shift-under-load element 40, 40′ disengages again, whereupon the diversion of the torque flow via the auxiliary shafts 48, 49 or 48′, 49′ ceases and the traction-force-supported gearshift is completed.

### List of Indexes

1,1 Two-countershaft transmission
2 Splitter group
3 Main transmission
4 Range group
5 Transmission input
6 Driveshaft
7 Double clutch
8, 8 Countershaft
9, 9 Countershaft
10 Fixed wheel
11 Loose wheel
12 Fixed wheel
13 Fixed wheel
14 Loose wheel
15 Fixed wheel
16 Shift device
17 Transmission input shaft
18 Fixed wheel
19 Loose wheel
20 Fixed wheel
21 Fixed wheel
22 Loose wheel
23 Fixed wheel
24 Fixed wheel
25 Intermediate wheel
26 Loose wheel
27 Intermediate wheel
28 Fixed wheel
29 Shift device
30 Main transmission shaft
31 Shift device
32 Planetary gearset
33 Planetary gear carrier
34 Sun gear
35 Ringgear
36 Transmission output shaft
37 Shift device
38 Housing
39 Clutch input portion
40, 40′ Shift-under-load element
41, 41′ Starting element
42, 42′ Drive input gearset
43, 43′ Loose wheel
44 Intermediate wheel
45 Intermediate wheel
46, 46′ Fixed wheel
47, 47′ Fixed wheel
48, 48′ Auxiliary shaft
49, 49′ Auxiliary shaft
50, 50′ Drive output gearset
51, 51′ Fixed wheel
52, 52′ Fixed wheel
53 Intermediate wheel
54 Intermediate wheel
55, 55′ Fixed wheel
56 Clutch output portion
57 Clutch output portion
58 Clutch output portion
59 Clutch input portion
60 Clutch input portion
61 Clutch output portion
62 Drive output gearset
63 Loose wheel
64 Loose wheel
65 Fixed wheel
66 Shift device
67 Shift device
iₖ₁ Splitter group gear constant
iₖ₂ Splitter group gear constant
i₁ Main transmission gear
i₂ Main transmission gear
i₃ Main transmission gear
i_{R} Main transmission reverse gear

1-14. (canceled)

15. A multi-group transmission of a motor vehicle having at least two transmission groups (2, 3) arranged in a drivetrain in which means are provided for engaging an intermediate gear in order to reduce or avoid a traction force interruption during gearshifts, the transmission comprising:
a starting element (41, 41′) and a shift-under-load element (40, 40′) being arranged between a drive shaft (6), which actively connected to a drive motor, and a transmission input (5), such that by the shift-under-load element (40, 40′) and via at least one auxiliary shaft (48, 48′, 49, 49′) with a drive input gearset (42, 42′) and at least one drive output gearset (50, 50′), bypassing at least a main group (3) and independently of an extent to which the starting element (41, 41′) is disengaged, an active connection is formed between the drive shaft (6) and a transmission output shaft (36).

16. The multi-group transmission according to claim 15, wherein three transmission groups (2, 3, 4) are provided such that an upstream, two-gear splitter group (2), associated with a transmission input shaft (17) and a central multi-gear main group (3) associated with a main transmission shaft (30), together form a countershaft transmission and a downstream range group (4) is formed as a planetary transmission.

17. The multi-group transmission according to claim 15, wherein the starting element (41) and the shift-under-load element (40) are formed as a double clutch (7) that constitutes a structural unit, an input component (39) of the double clutch (7) is connected to the drive shaft (6), an output component (57) of the starting element (41) is connected to a transmission input shaft (17), and an output component (56) of the shift-under-load element (40) is connected to a loose wheel (43) of a drive input gearset (42) mounted for rotation on the transmission input shaft (17).

18. The multi-group transmission according to claim 15, wherein the shift-under-load element (40′) and the starting element (41′) are arranged one after another as separate elements such that an input component (59) of the shift-under-load element (40′) and an input component (60) of the starting element (41′) are connected to one another and to the drive shaft (6), an output component (61) of the starting element (41′) is connected to a transmission input shaft (17) and an output component (58) of the shift-under-load element (40′) is connected to a loose wheel (43′) of the drive input gearset (42′) mounted to rotate on the transmission input shaft (17).

19. The multi-group transmission according to claim 15, wherein a loose wheel (43, 43′) of the drive input gearset (42, 42′) is directly engaged with a fixed wheel (46, 46′, 47, 47′) arranged on the at least one auxiliary shaft (48, 48′, 49, 49′), or meshes with an additional, intermediate wheel (44, 45) which is engaged with the fixed wheel (46, 46′, 47, 47′).

20. The multi-group transmission according to claim 15, wherein the at least one drive output gearset (50, 50′) is arranged at a level of a transmission output shaft (36) and comprises a fixed wheel (51, 51′, 52, 52′) arranged on the at least one auxiliary shaft (48, 48′, 49, 49′), which is either directly engaged with a fixed wheel (55, 55′) arranged on a transmission output shaft (36) or meshes with an additional, intermediate wheel (53, 54) which is engaged with the fixed wheel (51, 51′, 52, 52′) on the transmission output shaft (36).

21. The multi-group transmission according to claim 16, wherein the at least one output gearset (50, 50′) is arranged downstream from the main group (3) and comprises a fixed wheel (51, 51′, 52, 52′) arranged on the at least one auxiliary shaft (48,48′, 49, 49′), which either engages directly with a fixed wheel (55, 55′) arranged on the main transmission shaft (30) or meshes with an additional, intermediate wheel (53, 54) engaged with the fixed wheel (51, 51′, 52, 52′) on the main transmission shaft (30).

22. The multi-group transmission according to claim 16, wherein in addition a second drive output gearset (62) is arranged downstream from the main group (3) and comprises a loose wheel (63, 64), arranged on the at least one auxiliary shaft (48, 48′, 49, 49′), that engages directly with a fixed wheel (65) either arranged on the main transmission shaft (30) or meshes with an additional, intermediate wheel which engages with a fixed wheel on the main transmission shaft (30), and a shift device (66, 67), that interrupts the auxiliary shaft (48, 48′, 49,49′), is arranged between the two output gearsets (50, 50′; 62) which either connects the loose wheel (63, 64) of the second output gearset (62) rotationally fixed to the auxiliary shaft (48, 48′, 49, 49′) or closes the interruption of the auxiliary shaft (48, 48′, 49, 49′) by frictional means.

23. The multi-group transmission according to claim 22, wherein the second drive output gearset (62) is arranged between the main group (3) and the range group (4).

24. The multi-group transmission according to claim 15, wherein at least one counter shaft (8′, 9′) is a hollow shaft through which the at least one auxiliary shaft (48′, 49′) passes coaxially, the at least one auxiliary shaft (48′, 49′) an intermediate gear shaft.

25. The multi-group transmission according to claim 15, wherein two auxiliary shafts (48, 48′, 49, 49′) are arranged axially-parallel with one another as intermediate gear shafts through which the force flow of the intermediate gear branches.

26. A method for operating a multi-group transmission (1, 1′) of a motor vehicle with at least two transmission groups (2, 3) arranged in a drivetrain, to reduce or avoid a traction force interruption during a gearshift, the method comprising the steps of:
engaging an intermediate gear by forming an active connection, which bypasses at least a main group (3), between a driveshaft (6) and a transmission output shaft (36) by at least one auxiliary shaft (48,48′, 49, 49′) made as an intermediate gear shaft, so that upon at least partially engaging a starting element (41, 41′), arranged between the driveshaft (6) and a transmission input shaft (17), the main group (3) is shifted while free from load,
disengaging an engaged original gear,
synchronizing the speed of a drive motor that drives the driveshaft (6), while a shift-under-load element (40, 40′) is in slipping operation, to a connection speed of a target gear,
engaging a target gear when the connection speed has been reached; and
disengaging the shift-under-load element (40, 40′).

27. The method according to claim 26, further comprising the step of engaging the intermediate gear either by a first drive output gearset (50, 50′) associated with the at least one auxiliary shaft (48, 48′, 49, 49′), which co-operates directly with the transmission output shaft (36), or by a second drive output gearset (62) associated with the at least one auxiliary shaft (48, 48′, 49, 49′), which co-operates with a main transmission output shaft (30) that is in active connection with the transmission output shaft (36).

28. The method according to claim 26, further comprising the step of retaining engagement of the intermediate gear while the starting element (41, 41′) is fully engaged.
